(19) United States
(12) Patent Application Publication
(10) Pub. No.: US 2015/0088666 A1
(43) Pub. Date: Mar. 26, 2015

(54) SYSTEMS AND METHODS FOR AGGREGATING AND RANKING DATA FROM A PLURALITY OF SOURCES

(71) Applicant: Howard Lefkowitz, Henderson, NV (US)

(72) Inventor: Howard Lefkowitz, Henderson, NV (US)

(21) Appl. No.: 14/498,477

(22) Filed: Sep. 26, 2014

Related U.S. Application Data
(60) Provisional application No. 61/882,862, filed on Sep. 26, 2013.

(51) Int. Cl. G06Q 30/02; G06F 17/30

(52) U.S. Cl. CPC G06Q 30/0276; G06F 17/3053
USPC 705/14.72

(57) ABSTRACT

A system may aggregate inventory data from a plurality of databases and determine costs associated with the inventory data. For example, the system may receive product data from a plurality of sources. The product data may be for a same product contained in multiple databases. The system may determine whether the received product data corresponds to products in other inventories. A unique identifier may be assigned to each distinct product. For products available from multiple sources, the system may determine which source allows a largest margin to be captured. The determination may be performed in real time in response to a user query and/or may be saved. Based on the margin that can be captured, the system may determine an offer price for each product. The offer price may be presented to consumer users through user interfaces. Orders received from consumer users may be filled by the system.

### RELATED APPLICATIONS

This application claims priority to and the benefit of U.S. Provisional Patent Application No. 61/882,862, filed Sep. 26, 2013, which is hereby incorporated by reference herein in its entirety.

### Technical Field

This disclosure relates to systems and methods for aggregating and ranking data from a plurality of sources as well as to providing access to the data.

### BRIEF DESCRIPTION OF THE DRAWINGS

FIG. 1 is a schematic diagram of a system for determining offers to be provided to consumer users.

FIG. 2 is an exemplary screen display from a system identifying locations during loading of data from a source.

FIG. 3 is an exemplary screen display provided to a business user by a system identifying products during loading of data from a source.

FIG. 4 is an exemplary screen display of a list of stored products provided to a business user.

FIG. 5 is an exemplary screen display provided to business users of user interfaces through which stored product data is presented to consumer users.

FIG. 6 is a flow diagram of a method for determining offers to be provided to consumer users.

FIG. 7 is a flow diagram of a method for loading and mapping an inventory received from a source.

### DETAILED DESCRIPTION OF PREFERRED EMBODIMENTS

A system may aggregate products from inventories from a plurality of sources (e.g., data feeds) and may present offers for the products in the inventories to consumer users of the system. In an embodiment, the products may be hospitality and/or entertainment services. For example, the system may allow a consumer user to select a city and a desired type of hospitality and/or entertainment service, and the system may provide matching products to the consumer user. Many products in the inventories may be identical (e.g., the inventories may be non-distinct), so the system may determine which source to use to fulfill an order for a particular product. For each product, the system may determine which source allows the largest margin to be captured. Based on the margin from the source providing the largest margin, the system may calculate an offer price for the product to provide to the consumer user.

The system may use a variety of methods to aggregate inventories. The system may request the inventories from the sources in response to a consumer user request. Alternatively, or in addition, the sources may notify the system when the inventory is updated, and/or the system may request the inventories periodically and/or aperiodically. The sources may include independent entities, partner entities, and/or the like. The system may receive the inventories via an application programming interface (API), as an extensible markup language (XML) document, as inputs to a user interface, and/or the like. The system may determine a location, such as a city name, an address, etc., for products being updated in or added to the inventories. The system may then determine whether each product is already saved in the system. If a new product is being added, the system may assign a unique identifier to the product. The system may save and/or update a data storage with the product information for the products being updated/added. The system may save, inter alia, retail price, wholesale price, shipping cost, and best margin. Alternatively, or in addition, the system may retrieve and analyze price information in real time in response to a consumer user query and may store the price information temporarily at most.

The system may determine for each product which source will allow the largest margin to be captured when the product is sold based on a retail price. At least one source may be a retail source from which the retail price can be determined. The system may compare the retail price for the product with the source price from each source to determine the source that allows the largest margin to be captured. The system may display the source to the consumer user and/or may record the source internally so the consumer user does not know the source. The system may save the largest margin and/or an indication of the source corresponding to the largest margin to the data storage, and/or the largest margin and/or corresponding source may be determined in real time and stored temporarily at most. In some embodiments, the retail source (and/or another source) may only provide a retail price and may pay a predetermined percentage (e.g., 5%, 8%, 10%, 12%, 15%, 18%, 20%, etc.) of the retail price for orders received from the system. Accordingly, the system may also determine whether the largest margin or the predetermined percentage of the retail price is larger (e.g., whether the predetermined percentage of the retail price is the largest margin).

The system may calculate a price to offer consumers based on the largest margin. For example, the system may discount the retail price by a predetermined amount and/or percentage based on the largest margin. The predetermined discounts may be tiered based on the size of the margin. The system may determine the tier based on the margin and select the discount for that tier. Examples of margin tiers may include some or all of 5%, 10%, 15%, 20%, 25%, 30%, 35%, 40%, 45%, 50%, and/or the like. Percentage discounts for the margin tiers may include .5%, 1%, 1.5%, 2%, 2.5%, 3%, 3.5%, 4%, 4.5%, 5%, and/or the like. The price for the product (e.g., the price computed by discounting the retail price) may be presented to the consumer user.

The system may present the price to the consumer user in various ways. The system may directly interact with consumers and/or may provide the prices to an intermediary. The system may present the prices using a website, a mobile app or mobile device, a call center, and/or the like. The prices may be provided in response to a consumer user request. For example, the consumer user may specify the type of product and/or a location of interest (e.g., a city, neighborhood, or the like). The system may also allow the consumer user to purchase the product. In an embodiment, the consumer user may submit purchase and/or booking information directly to the system, and the system may fulfill the purchase without the consumer user needing to interact with another entity.

The system may be implemented as a computer system. Embodiments may include various steps, which may be embodied in machine-executable instructions to be executed by a computer system. A computer system includes one or more general-purpose or special-purpose computers (or other electronic devices). Alternatively, the computer system may include hardware components that include specific logic for performing the steps or include a combination of hardware, software, and/or firmware. Without limitation, a computer system may include a workstation, laptop computer, disconnectable mobile computer, server, mainframe, cluster, so-called “network computer” or “thin client,” tablet, smartphone, personal digital assistant or other hand-held computing device, “smart” consumer electronics device or appliance, or a combination thereof. A server may include a physical server, a server cluster, a distributed server, a virtual server, a cloud server, a computer providing resources to one or more clients, a combination of one or more of the aforementioned, and/or the like. Some or all of the functions, steps, and/or operations discussed herein may be performed by one or more clients rather than a server. Those of skill in the art will realize many possible divisions of operations between servers and clients.

Each computer system includes at least a processor and a memory; computer systems may also include various input devices and/or output devices. The processor may include one or more general-purpose central processing units (CPUs), graphic processing units (GPUs), or Digital Signal Processors (DSPs), such as Intel®, AMD®, Nvidia®, ATI®, TI®, or other “off-the-shelf” microprocessors. The processor may include a special-purpose processing device, such as ASIC, PAL, PLA, PLD, FPGA, or other customized or programmable device. The memory may include static RAM, dynamic RAM, flash memory, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computers may be capable of using a floppy drive, tape drive, optical drive, magneto-optical drive, memory card reader, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Embodiments may also be provided as a computer program product, including a non-transitory machine-readable storage medium having stored thereon instructions that may be used to program a computer (or other electronic device) to perform processes described herein. The non-transitory machine-readable storage medium may include, but is not limited to, hard drives, floppy diskettes, optical disks, CD-ROMs, DVD-ROMs, ROMs, RAMs, EPROMs, EEPROMs, magnetic or optical cards, tapes, solid-state memory devices, or other types of media/machine-readable media suitable for storing electronic instructions.

Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies. One suitable network includes a server and several clients; other suitable networks may contain other combinations of servers, clients, and/or peer-to-peer nodes, and a given computer may function both as a client and as a server. Each network includes at least two computer systems, such as servers and/or clients.

The network may include communications or networking software, such as the software available from Novell, Microsoft, Artisoft, and other vendors, and may operate using TCP/IP, SPX, IPX, and other protocols over twisted pair, coaxial or optical fiber cables, telephone lines, satellites, microwave relays, modulated AC power lines, physical media transfer, and/or other data transmission “wires” or wireless networks known to those of skill in the art. The network may encompass smaller networks and/or be connectable to other networks through a gateway or similar mechanism.

Suitable software to assist in implementing the invention is readily provided by those of skill in the pertinent art(s) using the teachings presented here and programming languages and tools, such as Java, Pascal, C++, C, PHP, JavaScript, Python, C#, Perl, SQL, Ruby, Shell, Visual Basic, Assembly, Action Script, Objective C, Lisp, Scala, Tcl Haskell, Scheme, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, comprise one or more physical or logical blocks of computer instructions, which may be organized as a routine, a program, a script, an object, a component, a data structure, etc., that performs one or more tasks or implements particular abstract data types.

In certain embodiments, a particular software module may comprise disparate instructions stored in different locations of a memory device, different memory devices, or different computers, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that may be used according to the present invention is already available, such as general-purpose computers, computer programming tools and techniques, computer networks and networking technologies, and digital storage media.

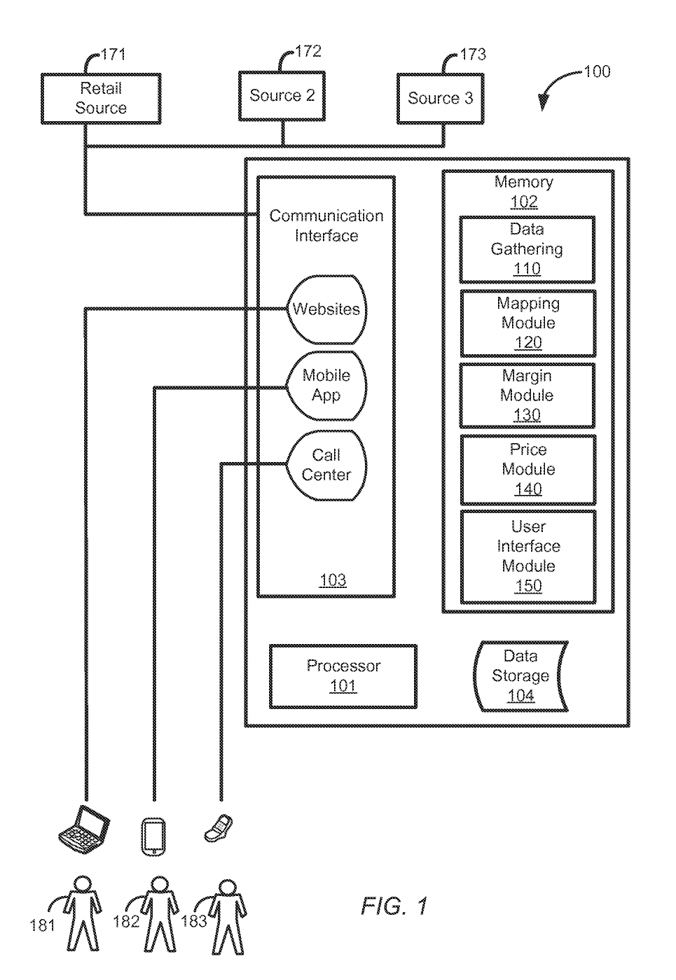

FIG. 1 is a schematic diagram of a system 100 for determining offers to be provided to consumer users. The system 100 may include a processor 101, a memory 102, a communication interface 103, a persistent storage device 104 (e.g., a persistent, computer-readable storage medium), and/or the like. The memory 102 may include a plurality of modules (e.g., modules 110-150) configured to cause the processor to perform steps contained therein. The communication interface 103 may be communicatively coupled with a plurality of sources 171, 172, 173 and may be communicatively coupled with a plurality of consumer users 181, 182, 183.

A data gathering module 110 may be configured to control communications with the plurality of sources 171, 172, 173 and to parse received data. The data gathering module 110 may determine when to request inventory data from the plurality of sources 171, 172, 173 (e.g., pulled by the data gathering module) and/or may receive updates from the plurality of sources 171, 172, 173 (e.g., pushed by the plurality of sources). To parse received data, the data gathering module 110 may determine a format of received inventory data, extract the inventory data, and translate the inventory data into a format that is recognized by the system 100.

A mapping module 120 may receive the parsed inventory data from the data gathering module 110. For each product in the inventory data, the mapping module 120 may determine whether an entry in the persistent storage device 104 already exists. If an entry already exists, the mapping module 120 may modify the entry with any necessary updates. If an entry does not exist, the mapping module 120 may assign a unique identifier to the product and add an entry for the product to the persistent storage device 104.

A margin module 130 may determine for each product and/or each request by a consumer user, which source 171, 172, 173 allows the largest margin to be captured. The margin module 130 may determine the margin for each source 171, 172, 173 by subtracting the source price from a retail price received from a retail source 171, by calculating a commission paid by the retail source 171 (e.g., a predetermined percentage of the retail price paid by the retail source 171), and/or the like. The margin module 130 may determine which margin is largest. The margin module 130 may save the largest margin, the source corresponding to the largest margin, and/or the like to the persistent storage device 104. The margin module 130 may save the largest margin as a percentage, an absolute amount, both, and/or the like. Alternatively, the largest margin and/or corresponding source may be determined in real time in response to a consumer user query and stored temporarily at most.

A price module 140 may determine what price should be offered to consumer users based on the largest margin that can be captured. The price module 140 may calculate the offer price by discounting the retail price by a percentage or amount determined based on the size of the largest margin. The price module 140 may compare the largest margin to a predetermined set of ranges to determine which range contains the largest margin. Each range may have a corresponding discount that the price module 140 applies to the retail price. The offer price calculated by the price module 140 may be saved to the persistent storage device 104, and/or may be calculated in real time and stored temporarily at most.

A user interface module 150 may provide the calculated offer price to the consumer users 181, 182, 183. A first consumer user 181 may interact with the system 100 through a website 161. A second consumer user 182 may interact with the system 100 through a mobile app or mobile device 162. A third consumer user 183 may interact with the system 100 through a call center 163. For example, a call center employee and/or automated call system may navigate the user through the available products in the data storage 104. The user interface module 150 may manage the user interfaces (e.g., the website 161, mobile app or mobile device 162, call center 163, etc.) and may ensure that the offer price provided by the user interfaces 161, 162, 163 is up to date. The user interface module 150 may provide the users 181, 182, 183 with access to information in the data storage 104 (e.g., products, product information, offer prices, etc.). The user interface module 150 may also allow consumer users 181, 182, 183 to purchase offered products. The user interface module 150 may request and/or receive purchase information (e.g., information necessary for the system 100 to request electronic payment), booking information (e.g., information required by the source 171, 172, 173 with the largest margin and/or a supplier (not shown) to fulfill the purchase), and/or the like. The user interface module 150 may fulfill the purchase using the received information. Payment processing may be provided by the user interface module 150 and/or by the source used to fulfill the purchase.

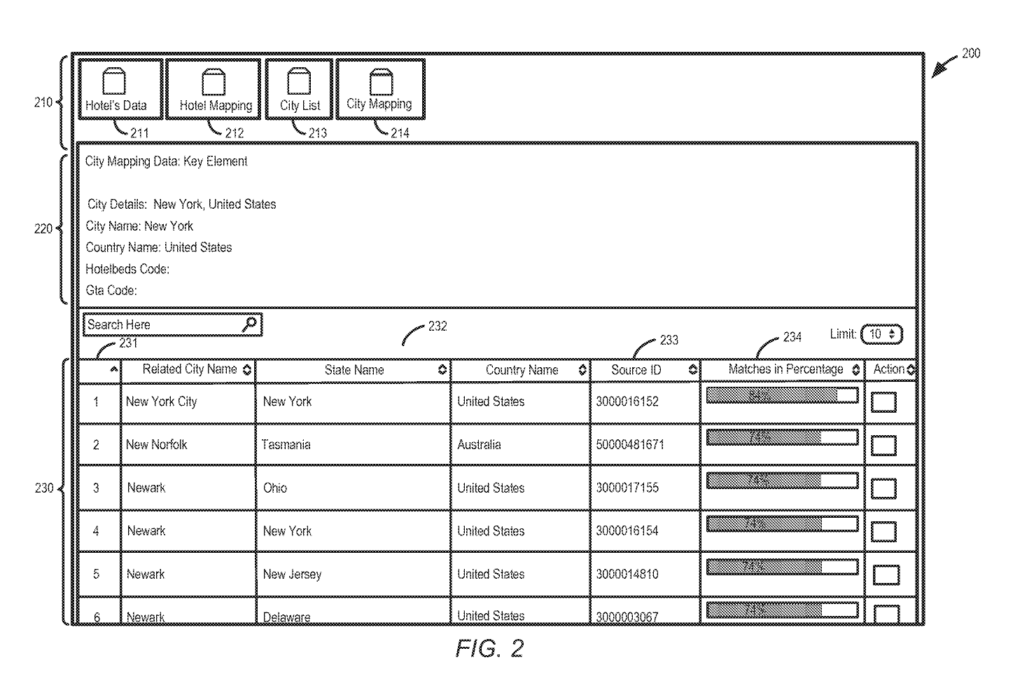

FIG. 2 is an exemplary screen display 200 from a system identifying locations during loading of data from a source. The screen display 200 may be provided to a user with administrative access rights (e.g., a business user) for managing the system and/or persistent storage device. The screen display 200 may include a navigation bar 210 with a plurality of buttons for viewing and/or modifying product data 211 (e.g., hotel data), product mappings 212, location data 213, location mappings 214, and/or the like. The screen display 200 may indicate loaded location data 220 for one or more products loaded from the source. The loaded location data 220 may include information from which a location can be identified, such as a city name, a state or province name, a country name, a postal code, a country code, and/or the like. The screen display 200 may also include likely matches 230 determined based on the loaded location data 220. For the likely matches 230, the screen display 200 may include a match ranking 231, stored location data 232 (e.g., a city name, a state or province name, a country name, a postal code, a country code, etc.), a unique identifier 233 assigned to each location by the system, a match percentage 234 (e.g., a score indicative of how closely the stored location data 232 matches the loaded location data 220), and/or the like.

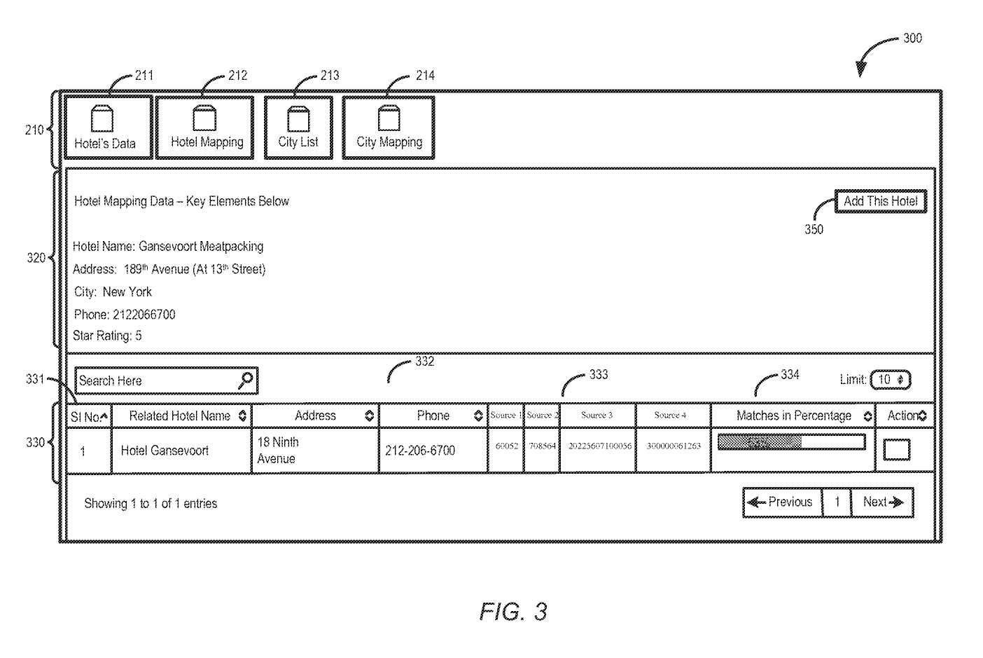

FIG. 3 is an exemplary screen display 300 provided to a business user by a system identifying products during loading of data from a source. The screen display 300 may indicate loaded product data 320 for a product loaded from the source. The loaded product data 320 may include information from which the product can be identified, such as a product name, an address, a city name, a phone number, a rating, a time and/or date, and/or the like. The screen display 300 may also include likely matches 330 determined based on the loaded product data 320. For example, the screen display 300 may indicate a match ranking 331, stored product data 332 (e.g., a product name, an address, a city name, a phone number, a rating, a time and/or date, etc.), one or more source identifiers 333 used by the sources to identify the product, a match percentage 334 (e.g., a score indicative of how closely the stored product data 332 matches the loaded product data 320), and/or the like for each stored product. An input button 350 may allow the loaded product to be saved as a new product. Alternatively, or in addition, the system may automatically determine whether the loaded product should be saved as a new product, for example, based on the match percentage 334.

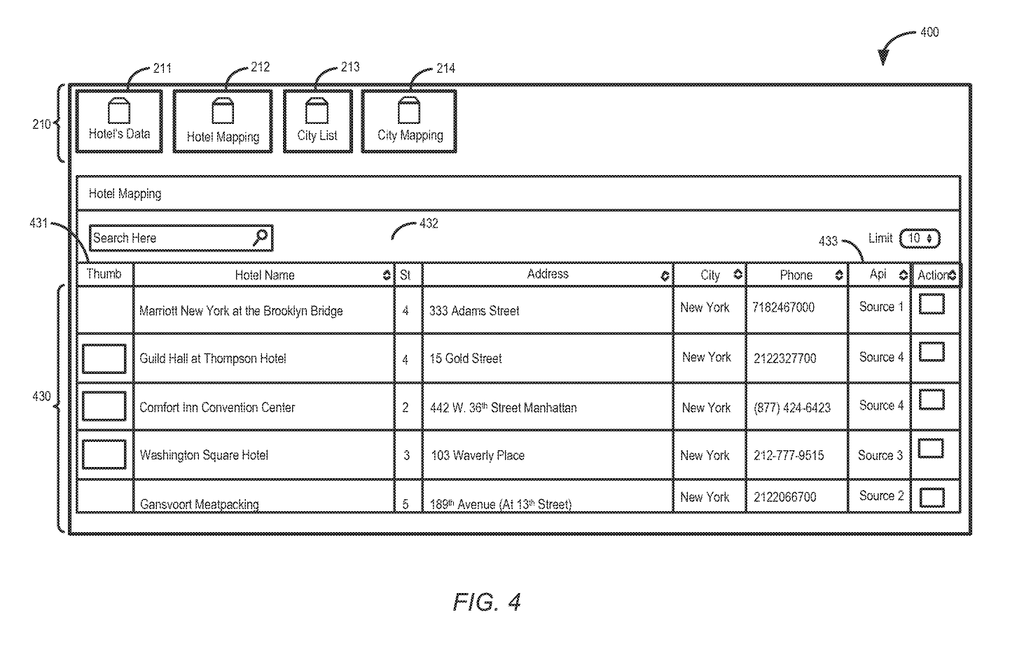

FIG. 4 is an exemplary screen display 400 of a list of stored products 430 provided to a business user. The list of stored products 430 may indicate which products have been loaded into a system based on a set of business rules. The list of stored products 430 may include a thumbnail image 431, product identifying information 432 (e.g., a product name, an address, a city name, a phone number, a rating, a time and/or date, etc.), sources offering the product 433, and/or the like for each stored product. The list of stored products 430 may indicate products that will be presented to consumer users accessing the system.

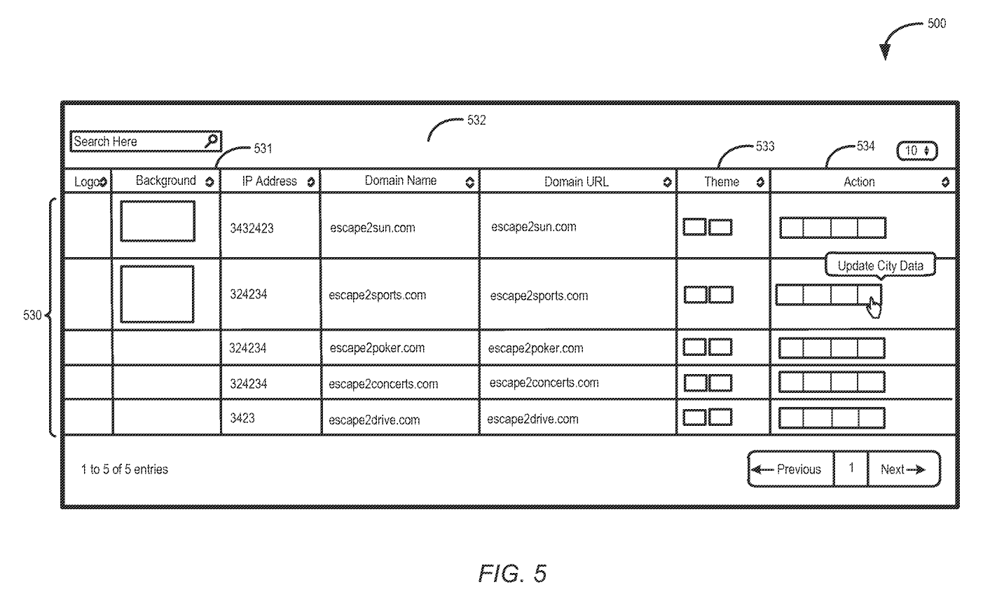

FIG. 5 is an exemplary screen display 500 provided to business users managing user interfaces through which stored product data is presented to consumer users. The screen display 500 may include a list of interfaces 530 through which consumer users can access stored products. For example, specific user interfaces may be associated with certain products, certain locations, and/or the like. Accordingly, a consumer user may view some products when using one user interface but not when using another (e.g., a user interface associated with a location may only display products associated with that location). The list of interfaces 530 may include background images 531, identifying information 532 for the interface (e.g., an internet protocol address, a domain name, a domain URL, etc.), theme colors 533, administrator inputs 534, and/or the like for the user interfaces. The administrator inputs 534 may allow a business user with administrative privileges to associate products and/or locations with user interfaces, review analytical data on consumer users accessing the interfaces, and/or the like. Alternatively, or in addition, the system may automatically determine which products should be associated with which interfaces. For example, the system may determine based on a user interface theme (e.g., location, type of service, price, etc.) which interfaces should receive which products for presentation to users. In an embodiment, a mobile app may receive product data based on a location (e.g., a location determined by a satellite navigation system) of a user of the mobile app (e.g., based on neighborhood, city, region, etc. where the user is located and/or a predetermined distance from the user). Alternatively, or in addition, the user may specify locations of interest.

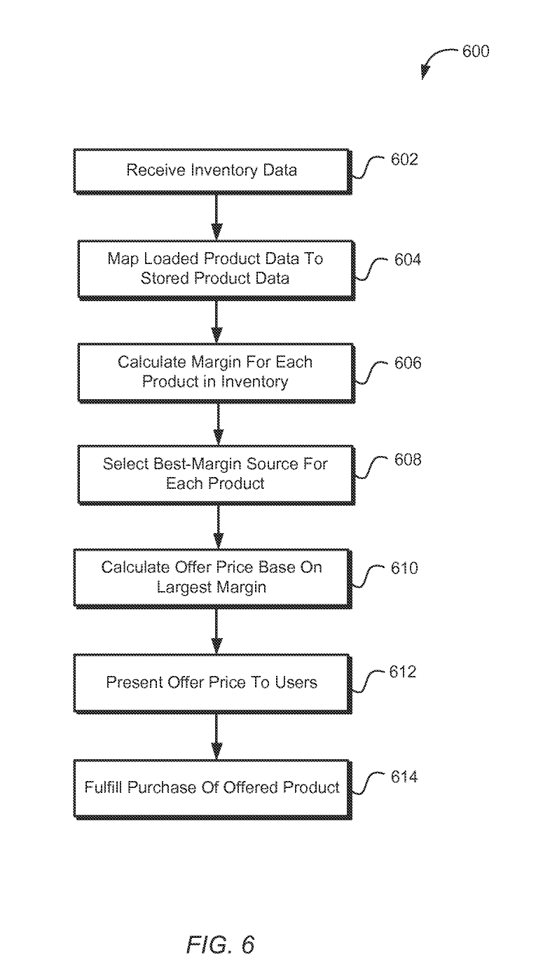

FIG. 6 is a flow diagram of a method 600 for determining offers to be provided to consumer users. The method 600 may begin by receiving 602 inventory data from a plurality of sources, including a retail source. The inventory data may include price information for one or more products. The inventory data may be received in response to a request sent to the plurality of sources. The inventory data need not be received from the plurality of sources at the same time. For example, one source may update its inventory, and the inventory data may be received only from the source with the updated inventory. The update may be received at the time it is made or a predetermined time for pulling updated information. The inventory data from the non-updated sources may have been received previously. Receiving 602 the inventory data may include parsing the inventory data from a data structure.

Loaded product data in the received inventory data may be mapped 604 to stored product data that has been received previously. If data for a product has not been received previously, a unique identifier may be assigned to the product and a new entry may be created for the product. Otherwise, the loaded product data may be associated with the already existing unique identifier for that product. A margin may be calculated 606 for each product in the received inventory data. The margin may be calculated 606 by subtracting a source price from a retail price. The retail price for each product may be determined, for example, by receiving the retail price from a retail source. The source price charged by the source may be included in the loaded product data. The calculated margin may be saved, and/or the margin may be calculated 606 in real time in response to a consumer user query and may be stored temporarily at most.

A best-margin source may be selected 608 for each product (or for the requested product). The calculated margins from each source for a particular product may be compared to determine which margin is largest. The retail source and/or one or more other sources may pay a commission based on the retail price for sale of the product, so the commission revenue(s) may be computed from the retail price and compared with the margins for the product from other sources and/or the largest of the margins from other sources to determine which yields the most revenue. In some embodiments, the commission revenue(s) may be calculated in step 606 and saved. The value of the largest margin (e.g., as a percentage, absolute amount, etc.) and/or an indication of the corresponding source may be saved, and/or the best-margin source may be selected 608 in real time in response to a consumer user query and may be stored temporarily at most.

An offer price may be calculated 610 based on the largest margin. The retail price may be discounted to calculate 610 the offer price. In an embodiment, the discount may be a percentage off the retail price, and the discount may be determined from the margin as a percentage of the retail price. A larger percentage discount may correspond to a larger percentage margin. A plurality of ranges for the percentage margin may be stored, and the discount percentage may be determined based on which range contains the percentage margin (e.g., each range may correspond to a predetermined discount percentage). Alternatively, or in addition, an absolute discount amount may be determined based on an absolute margin amount. Various formulas for determining discount from margin, marginal costs, fixed costs, total costs, and/or the like are contemplated.

The calculated offer price may be presented 612 to consumer users via one or more user interfaces. Consumer users may request offer prices for one or more products using the user interfaces. For example, the consumer user may submit a search query for particular types of products, particular product locations, and/or the like. Products matching the search query and corresponding offer prices may be returned to the consumer user in response to the search. The user interfaces may include one or more websites, mobile applications (e.g., an application for a mobile device, smartphone, tablet, etc.), call centers, and/or the like. A purchase of an offered product by a consumer user may be fulfilled 614. Fulfilling 614 the purchase may include receiving user information, such as purchase information, booking information, and/or the like. The product may be purchased for the consumer user through the best-margin source, for example, by submitting to the best-margin source any information required to execute the purchase. For example, fulfilling 614 may include determining which information is required by the best-margin source, presenting a form or interface to the user requesting the determined information, receiving the information from the user, validating the information from the user, and providing the information to the best-margin source. Fulfillment 614 may performed in real-time and/or in less than a predetermined time. The offer for the product may be validated during fulfillment to ensure it is still available at the offered price.

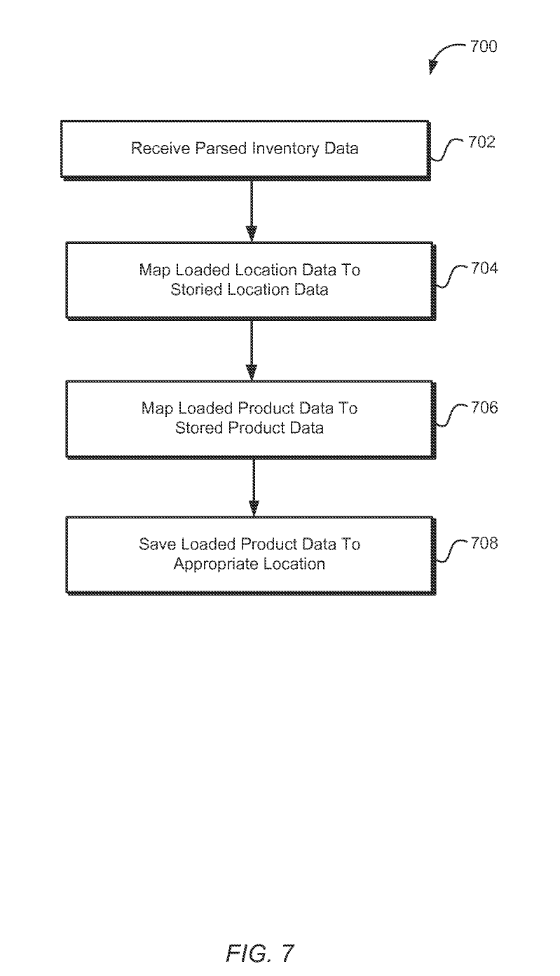

FIG. 7 is a flow diagram of a method 700 for mapping an inventory received from a source. The method 700 may begin with receiving 702 inventory data that has been parsed. The inventory data may include location data, product data, and/or the like for one or more products. Some of the location data may be the same for multiple of the one or more products. The loaded location data may be mapped 704 to stored location data. For example, products may be classified by division or group (e.g., by geopolitical division, such as a city). Accordingly, the loaded location classifications may be mapped to stored location classifications to ensure products are divided into the same groupings. Mapping 704 may include comparing location names, geographic coordinates or boundaries, and/or the like. For each loaded location, a most likely match from among stored locations may be determined based on a scoring algorithm. If a score for the most likely match exceeds a predetermined threshold, the loaded location may be mapped to the most likely match.

The loaded product data may be mapped 706 to stored product data. For each product in the loaded inventory data, loaded product data may be compared with stored product data for one or more products. From mapping 704, the locations for each product in the loaded inventory data and for each stored product may be known, so loaded product data may be compared with stored product data only if the location matches. A most likely match for each product may be determined from the comparison using a scoring algorithm. If a score for the most likely match exceeds a predetermined threshold, the loaded product data may be mapped to the mostly likely match. If no scores exceed the predetermined threshold, a new unique identifier may be created for the loaded product data. Next, the loaded product data may be saved 708. If a match was found, saving 708 may include updating stored data. If no match was found, saving 708 may including creating and storing a new data entry.

It will be understood by those having skill in the art that many changes may be made to the details of the above-described embodiments without departing from the underlying principles of the disclosure. The scope of the present disclosure should, therefore, be determined only by the following claims.

1. A system for aggregating and ranking data from a plurality of sources, the system comprising:
a communication interface configured to receive inventory data from a plurality of remote databases, wherein the inventory data includes costs for a plurality of elements in each remote database; and
a processor configured to:
for an element in the plurality of remote databases, select a source that allows a largest margin to be captured, and
calculate an offer based on the largest margin,
wherein the communication interface is configured to communicate the offer to a user-interfacing system for presentation to a user.

2. The system of claim 1, wherein the processor is further configured to map the inventory data to stored products based on a location associated with each element.

3. The system of claim 2, wherein the processor is further configured to map the inventory data to the stored products by calculating a match score between each element and each stored product, and wherein the processor maps each element to a stored product with a highest match score above a predetermined threshold.

4. The system of claim 3, wherein the processor is further configured to create an entry for a new stored product when the highest match score is below the predetermined threshold.

5. The system of claim 1, wherein the processor is further configured to select a plurality of user-interfacing systems to receive the offer by determining a relevance of the offer to each user-interfacing system.

6. The system of claim 1, wherein at least one of the plurality of remote databases includes a retail price for the element, and wherein the processor selects the source that allows the largest margin to be captured by subtracting a source price for the element in each remote database from the retail price.

7. The system of claim 6, wherein the at least one of the plurality of remote databases includes a percentage commission for the element, and wherein the processor computes a margin for the at least one of the plurality of remote databases by multiplying the percentage commission and the retail price.

8. The system of claim 6, wherein the processor calculates the offer by selecting a discount to the retail price, and wherein the discount is selected based on a size of the largest margin.

9. A method for aggregating and ranking data from a plurality of sources, the method comprising:
receiving and storing inventory data from a plurality sources for a corresponding plurality of non-distinct inventories;
for a product in the plurality of inventories, selecting, using a processor, a source that allows a largest margin to be captured; and
calculating, using the processor, an offer price for the product based on the largest margin.

10. The method of claim 9, further comprising mapping the inventory data to stored products based on a location associated with each product in the inventory data.

11. The method of claim 10, wherein mapping the inventory data comprises calculating a match score between each product in the inventory data and each stored product, and mapping each product to a stored product with a highest match score above a predetermined threshold.

12. The method of claim 11, wherein mapping the inventory data comprises storing a new product when the highest match score is below the predetermined threshold.

13. The method of claim 9, further comprising transmitting the offer price to a plurality of user-interfacing systems for presentation to users.

14. The method of claim 13, further comprising selecting the plurality of user-interfacing systems by determining a relevance of the product to each user-interfacing system.

15. The method of claim 9, wherein the plurality of sources include a retail source, and wherein selecting the source that allows the largest margin to be captured comprises subtracting a source price for the product specified by each source from a retail price received from the retail source.

16. The method of claim 15, wherein the retail source indicates a percentage commission for the product, and wherein selecting the source that allows the largest margin to be captured comprises computing a margin for the retail source by multiplying the percentage commission and the retail price.

17. The method of claim 15, wherein calculating the offer price comprises selecting a discount from the retail price based on a size of the largest margin.

18. A non-transitory computer readable storage medium comprising program code, which when executed by a processor, causes the processor to:
receive inventory data from a plurality sources for a corresponding plurality of non-distinct inventories;
select a source that allows a largest margin to be captured for a product in the plurality of inventories; and
calculate an offer price for the product based on the largest margin.

19. The non-transitory computer readable storage medium of claim 18, wherein the program code is further configured to cause the processor to transmit transmitting the offer price to a plurality of user-interfacing systems, wherein the plurality of user-interfacing systems are selected by determining a relevance of the product to a theme of each user-interfacing system.

20. The non-transitory computer readable storage medium of claim 18, wherein the plurality of sources include a retail source, wherein the processor receives a retail price from the retail source, and wherein the processor selects the largest margin based on the retail price.
